(19) United States
(12) Patent Application Publication
(10) Pub. No.: US 2022/0367981 A1
(43) Pub. Date: Nov. 17, 2022

(54) FAULT TOLERANT BATTERY ARCHITECTURE

(71) Applicant: CAMX Power LLC, Lexington, MA (US)

(72) Inventor: Christopher H. McCoy, Sherborn, MA (US)

(21) Appl. No.: 17/693,669

(22) Filed: Mar. 14, 2022

Related U.S. Application Data
(60) Provisional application No. 63/188,529, filed on May 14, 2021.

(51) Int. Cl. H01M 50/512; H01M 50/51; H01M 4/505; H01M 4/525; H01M 4/485; H01M 10/0525

(52) U.S. Cl. CPC H01M 50/512; H01M 50/51; H01M 4/505; H01M 4/525; H01M 4/485; H01M 10/0525; H01M 2004/028

(57) ABSTRACT

Provided is a battery cell assembly that continues to operate near normal parameters following a fault in a cell. The battery cell assembly includes a plurality of repeating cell units. Each of the cell units is connected in parallel with another cell unit. Additionally, each of the cell units is connected in series with another cell unit. Each of the cell units includes n cells connected in series, the n cells having a voltage range tolerance of z % greater than a nominal operational voltage range. The n cells comprise a first end cell, a second end cell, and n−2 middle cells interposed between the first end cell and the second end cell. The middle cells are absent a parallel connection. In each of the cell units, n≥3 and z(n−1)≥100. Also provided is a method of compensating for a voltage loss from a shorted cell.

### CROSS REFERENCE TO RELATED APPLICATION

This application depends from and claims priority to U.S. Provisional Application No. 63/188,529 filed May 14, 2021, the entire contents of which are incorporated herein by reference.

### STATEMENT OF GOVERNMENT SUPPORT

This invention was made with government support under W56HZV-16-C-0143 awarded by the United States Army. The government has certain rights in the invention.

### TECHNICAL FIELD

The present specification generally relates to battery cell assemblies and, more specifically, to battery cell assemblies that continue to operate near normal parameters following a fault in a cell.

### BACKGROUND

Common battery cell assemblies include cells configured as block units in parallel with those units connected in series. Other variants see paralleling strings of individual series cells, and “fully matrixing” the cells with each cell parallel connected by row and series connected by column. In each of these cell assemblies, a failure of a single cell can significantly reduce battery performance.

For example, in the cell assembly shown in FIG. 1A, each of the series-connected units of the cell array is comprised of a set of parallel-connected cells. If a cell experiences a fault involving a short-circuit or other fault resulting in a discharge path for one cell, the current flow resulting from such faults will discharge not only the affected cell but also all other cells within the group of parallel-connected cells. The impact on overall battery performance will depend on the severity of the fault (i.e., the resistance of the discharge path arising from the fault) with potential outcomes including: reduction in available battery capacity, limited by the effective remaining operational capacity of the fault-containing set of cells; charge and discharge termination by battery management system for the battery as a result of the fault-containing group of parallel-connected cells having reduced operational capacity and on charging reaching the overvoltage protection threshold or on discharging reaching the undervoltage protection threshold; and loss of battery voltage due to reduced, or total loss, of one of the series units of parallel-connected cells.

It can be understood that the consequences of a short described with respect to the cell assembly shown in FIG. 1A apply to any battery of the general assembly of the type shown in FIG. 1A irrespective of the number of groups of cells connected in series, and of the number of cells connected in parallel comprising each of those series-connected units.

In the cell assembly shown in FIG. 1B, strings of series-connected cells are bussed in parallel at the top (e.g., positive end) and bottom (e.g., negative end) of the strings. Cells in a battery can be assembled as a set of series strings that are connected in parallel at the positive-most end of the string and in parallel at the negative-most end of the string. In the assembly of FIG. 1B, if a cell experiences a short circuit, the voltage loss to the associated series string will result in the other strings in parallel with it discharging into the string with the fault-containing cell, reducing available battery voltage and battery energy. It should also be noted that if a cell fails open circuit, the entire associated string of cells becomes inoperable because no current can flow through the cell which has failed open. Accordingly, operational battery capacity is reduced commensurate with the loss of the capacity contribution of that series string (i.e., by one-third in the assembly of FIG. 1B). It can be understood that this principle generalizes to cell assemblies of any number of cells in series comprising each of the series strings, and any number of parallel-connected series strings.

In the matrix cell assembly shown in FIG. 1C, each individual cell is connected in series to the cell above (or top bus in the case of the top-most cell) and the cell below (or bottom bus in the case of the bottom-most cell) in the array. In the assembly shown in FIG. 1C, if a cell shorts, the associated horizontal row of parallel cells will discharge into the short. This assembly can result in the same issues as the assembly shown in FIG. 1A.

In the event that a cell fails open, the available capacity of the associated horizontal row is reduced by the capacity of the failed cell, effectively reducing overall battery capacity by the same amount (as is the case for the cell assembly shown in FIG. 1B). However, unlike the assembly shown in FIG. 1B, the assembly shown in FIG. 1C retains electrical access to the cells in the series string containing the failed-open cell by virtue of the parallel connections of the matrix, though this retention of electrical access is not expected to alter the capacity loss due to a fail-open event of a cell.

It can be understood that the consequences of a fail-open or fail-short event as described with respect to the cell assembly shown in FIG. 1C apply in general to a series-parallel matrixed cell array irrespective of the number of cells per horizontal row or number of cells per vertical column.

### SUMMARY

The following summary is provided to facilitate and understanding of some of the innovative features unique to the present disclosure and is not intended to be a full description. A full appreciation of the various aspects of the disclosure can be gained by taking the entire specification, claims, drawings, and abstract as a whole.

According to one or more aspects, a battery cell assembly that continues to operate near normal parameters following a fault in a cell is provided. The battery cell assembly includes a plurality of repeating cell units. Each of the cell units is connected in parallel with another cell unit. Additionally, each of the cell units is connected in series with another cell unit. Each of the cell units includes n cells connected in series, the n cells having a voltage range tolerance of z % greater than a nominal operational voltage range. The n cells comprise a first end cell, a second end cell, and n−2 middle cells interposed between the first end cell and the second end cell. The middle cells are absent a parallel connection. In each of the cell units, n≥3 and z(n−1)≥100.

In some aspects, a method of compensating for a voltage loss from a shorted cell is provided. The method includes expanding an operational voltage range of n−1 operational cells of a cell unit by z % over a nominal operational voltage range such that z(n−1)≥100. The cell unit includes n cells connected in series, the n cells comprising a first end cell, a second end cell, and n−2 middle cells interposed between the first end cell and the second end cell. The middle cells are absent a parallel connection. The n cells include the shorted cell and the operational cells. In the cell unit, n≥3.

These and additional features provided by the present disclosure will be more fully understood in view of the following detailed description in conjunction with the drawings, abstract, and claims provided.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1A depicts a battery cell assembly according to at least one known art;

FIG. 1B depicts a battery cell assembly according to at least one other known art;

FIG. 1C depicts a battery cell assembly according to at least one other known art;

FIG. 2 depicts an illustrative battery cell assembly according to some aspects as provided herein; and

FIG. 3 depicts an illustrative cell unit comprising a shorted cell according to some aspects provided herein.

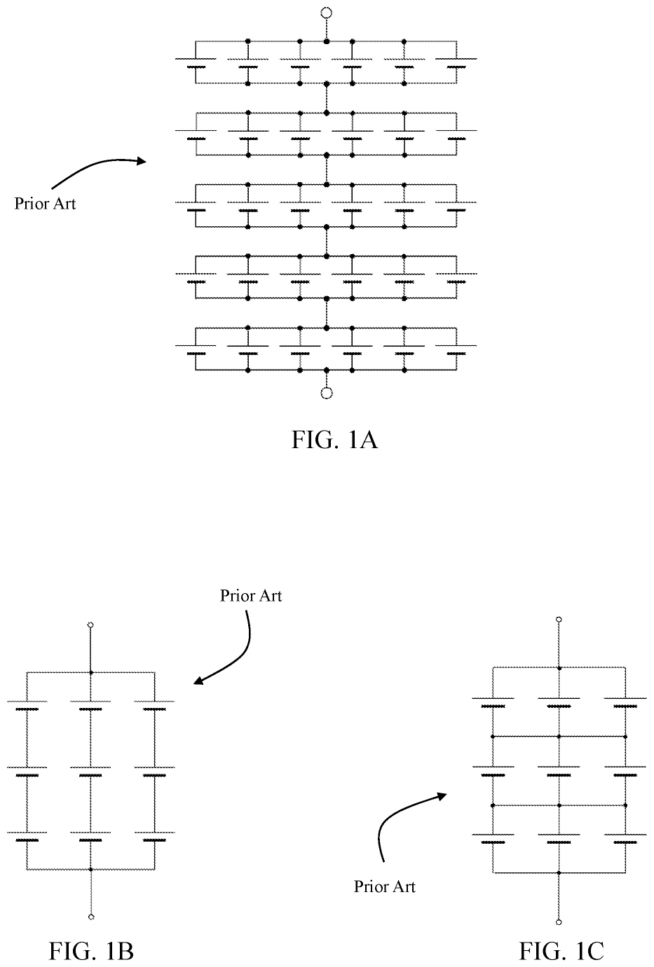

### DETAILED DESCRIPTION

In some aspects, a battery cell assembly that continues to operate near normal parameters following a fault in a cell is provided. The battery cell assembly includes cells with expanded voltage tolerance, which are cells with a normal, nominal operational voltage range for energy storage that can tolerate operation beyond that nominal operational voltage range without significant degradation to performance. According to aspects described herein, these cells can be utilized to create a fault-tolerant battery cell assembly in which the total voltage produced by a group of series-connected cells can be maintained even if one cell develops an internal short.

As used herein, “absorbing” can mean: intercalation or insertion or conversion alloying reactions of lithium with the active materials. Absorbing may be referred to herein as “lithiation.”

As used herein, “desorbing” can mean: de-intercalation or de-insertion or conversion de-alloying reactions of lithium with the active materials. Desorbing may be referred to herein as “dilithiation.”

As used herein, in the context of the lithium-ion cell, “cathode” means positive electrode and “anode” means the negative electrode.

As used herein an “active material” is a material that participates in electrochemical charge/discharge reaction of an electrochemical cell such as by absorbing or desorbing lithium.

According to one or more aspects, a battery cell assembly includes a plurality of repeating cell units connected to one another in a matrix. Thus, each of the cell units is connected in parallel with another cell unit. Additionally, each of the cell units is connected in series with another cell unit. The number of units connected in series and in parallel in the matrix will vary according factors including the specific tolerance of the cell utilized in the battery for operation over expanded voltage range, the desired capacity of the battery, and the desired stack voltage of the battery.

In some aspects of the battery cell assembly described herein, each cell unit includes n cells connected in series. The n cells include a first end cell, a second end cell, and n−2 middle cells interposed between the first end cell and the second end cell. The specific number of n cells connected in series may be selected according to criteria that results in a battery that can tolerate a failure in one or more cells without significant loss of functionality. In particular, the number of n cells connected in series may be selected based on their voltage range tolerance greater than a nominal operational voltage. If the n cells have a voltage range tolerance of z % greater than a nominal operational voltage range, the number of n cells may be selected so that n≥2 and z(n−1)≥100. The number of cells in each cell unit is not limited and may be determined by the needed or desired voltage tolerance range. Optionally, n is 2 or greater, optionally 3 or greater. Optionally, N is equal to or greater than 2, 3, 4, 5, 6, 7, 8, 9, 10, or more.

In some aspects, a method of compensating for a voltage loss from a shorted cell includes expanding an operational voltage range of n−1 operational cells of a cell unit by z % over a nominal operational voltage range such that z(n−1)≥100. According to one or more aspects, a shorted cell reduces the number of operational cells within that individual series unit but does not result in a short-circuit path through the individual series unit, as would occur in a single cell with a short. Further, should one cell develop a short circuit, the greater voltage range tolerance of the cells in the same cell unit that allow expanded operational voltage range beyond nominal (normal) operational voltage range allows the other, operational cells in the cell unit to continue to operate with little to no alteration in overall battery performance. Continued operation of the operational cells within the cell unit over an expanded voltage range compensates for the loss of voltage associated with the shorted cell.

The ability of the other cells in the respective cell unit to compensate for any voltage loss of any particular cell in the cell unit may be due to a combination of cell unit structure and/or chemistry of each individual cell in the cell unit. The number of cells in each cell unit may be determined by the needed tolerance for producing voltage above the nominal operational voltage of the cell and determined by the cell chemistry. As such, if n is 5 then, in some aspects, a desired cell chemistry would be one that may be capable of increasing voltage by 25% if one of the cells is shorted to a voltage of zero. The fact that the cells in each cell unit are linked in series and combined with the overall array architecture means that the presence of the shorted cell will not discharge any of the cells in the neighboring array units.

In some aspects, a cell includes an anode and a cathode that are capable when combined of operating at a desired voltage over the nominal operative voltage of the battery array. Optionally, an voltage over the nominal operating voltage is z % of the nominal operating voltage wherein z is at or greater than 1, 2, 3, 4, 5, 6, 7, 8, 9, 10, 15, 20, 30, 40, 50, 60, 70, 80, 90, or 100.

In some aspects, a cell includes an over voltage tolerant chemistry for the anode and cathode in each individual cell. It is noted that the chemistries of each individual cell may be identical or different from other cells in the cell unit or the units of the overall array. Optionally, a cell chemistry may include metal oxide cathode materials, and relevant anode materials. A cathode in an electrochemical cell as provided herein serves as the positive electrode. A cathode includes a polycrystalline cathode electrochemically active material that is capable of absorbing and desorbing Li. A cathode electrochemically active material as provided herein is optionally a material of the formula Li₁₊ₓMO_{2+y}, wherein −0.9≤x≤0.3, −0.3≤y≤0.3, and wherein M includes Ni at 80 atomic percent or higher relative to total M.

The cathode electrochemically active material optionally includes Ni as a predominant of the M component. The amount of Ni in the first composition is optionally from 80 atomic percent to 100 atomic percent (at %) of total M. Optionally, the Ni component of M is greater than or equal to 80 at %. Optionally, the Ni component of M is greater than or equal to 85 at %. Optionally, the Ni component of M is greater than or equal to 90 at %. Optionally, the Ni component of M is greater than or equal to 95 at %. Optionally, the Ni component of M is greater than or equal to 75 at %, 76 at %, 77 at %, 78 at %, 79 at %, 80 at %, 81 at %, 82 at %, 83 at %, 84 at %, 85 at %, 86 at %, 87 at %, 88 at %, 89 at %, 90 at %, 91 at %, 92 at %, 93 at %, 94 at %, 95 at %, 96 at %, 97 at %, 98 at %, 99 at %, 99.5 at %, 99.9 at %, or 100 at %.

In some aspects, M is Ni alone or in combination with one or more additional elements. The additional elements are optionally metals. Optionally, an additional element may include or be one or more of Al, Mg, Co, Mn, Ca, Sr, Zn, Ti, Y, Cr, Mo, Fe, V, Si, Ga, or B. In particular aspects, the additional element may include Mg, Co, Al, or a combination thereof. Optionally, the additional element may be Mg, Al, V, Ti, B, or Mn, or a combination thereof. Optionally, the additional element is selected from the group consisting of Mg, Al, V, Ti, B, or Mn. Optionally, the additional element selected from the group consisting of Mg, Co, and Al. Optionally, the additional element selected from the group consisting of Ca, Co, and Al. In some aspects, the additional element is Mn or Mg, or both Mn and Mg. Optionally, the additional element is Mn, Co, Al, or any combination thereof. Optionally the additional element includes Co and Mn. Optionally the additional element is Co and Al. Optionally the additional element is Co.

An additional element of M in the cathode electrochemically active material may be present in an amount of about 0.1 at % to about 20 at %, specifically about 5 to about 20 at %, more specifically about 10 at % to about 20 at % of M in the first composition. Optionally, the additional element may be present in an amount of about 1 at % to about 20 at %, specifically about 2 at % to about 18 at %, more specifically about 4 at % to about 16 at %, of M in the first composition. In some illustrative examples, M is about 80-100 at % Ni, 0-15 at % Co, 0-15 at % Mn, and 0-10 at % additional elements.

The cathode electrochemically active material as used in a cathode of a cell as provided herein optionally includes Co, Al, or both Co and Al wherein the Co, Al, or both is non-uniformly distributed through, on, or in the secondary particle of the cathode electrochemically active material. Non-uniform distribution is a distribution of Co that varies throughout some or all of the secondary particle. In some aspects, the polycrystalline material includes grain boundaries between adjacent crystallites within the secondary particle wherein a concentration of cobalt, aluminum, or both is higher in the grain boundary than in a center of the adjacent crystallites. Such, materials are considered grain boundary enriched materials. Illustrative examples of such grain boundary enriched materials can be found in U.S. Pat. Nos. 9,391,317 and 10,501,335.

In particular aspects, a secondary particle as used as a cathode electrochemically active material has a Co, Al, or both enriched grain boundary, optionally where the mole fraction of Co, Al, or both in the grain boundary is higher than a mole fraction of Co, Al, or both in the crystallites optionally as averaged throughout the sum of each region.

The composition of the crystallites, grain boundary region or both optionally has layered α-NaFeO₂-type structure, a cubic structure, or a combination thereof. An aspect in which the grain boundaries have the layered α-NaFeO₂-type structure is specifically mentioned. Another aspect in which the grain boundaries with α-NaFeO₂-type structure with defects is specifically mentioned. Another aspect in which parts of the grain boundaries have a cubic or spinel structure is specifically mentioned.

A grain boundary is optionally formed of a second composition of the formula I Li₁₊ₓMO_{2+y} (Formula 1) wherein −0.9≤x≤0.3, −0.3≤y≤0.3, and wherein M includes Co, Al, or a combination of Co and Al. Optionally M in a second composition further includes Ni. Optionally, the Ni component of M in the second composition is less than or equal to 1 at %. Optionally, the Ni component of M is less than or equal to 5 at %. Optionally, the Ni component of M is less than or equal to 10 at %. Optionally, the Ni component of M is less than or equal to 20 at %. Optionally, the Ni component of M is less than or equal to 75 at %. Optionally, the Ni component of M is less than or equal to 80 at %. Optionally, the Ni component of M is less than or equal to 90 at %. Optionally, the Ni component of M is less than or equal to 95 at %. Optionally, the Ni component of M is less than or equal to 98 at %. Optionally, the Ni component of M is less than or equal to 99 at %.

In a grain boundary enriched cathode electrochemically active material, the concentration of Co, Al, or both averaged through the grain boundary region is higher than the average concentration of Co, Al, or both averaged through the crystallite region. As such, the mole fraction of Co, Al, or both in the grain boundary is higher than the mole fraction of Co, Al, or both in the crystallites. The mole fraction of Co, Al, or both in the first composition, if Co, Al, or both are present at all in the crystallites, as defines the composition of the crystallites is lower than the mole fraction of the total Co or Al independently or combined in the total particle composition as determined by ICP. The mole fraction of Co and Al independently or combined in the crystallites can be zero. The mole fraction of Co and Al in the second composition independently or combined as defines the grain boundary is higher than the mole fraction of Co and Al independently or combined in the total particle as measured by ICP. The second composition may be enriched of Co of at or between 0 at % and 8 at %, optionally at or between 3 at % and 5 at % Co and optionally could be supplemented with 0.01 at % to 10 at % Al, optionally 1.5 at % or less Al.

Optionally a second composition and a first composition (crystallite composition) are identical with the exception of the presence of or increased concentration (mole fraction) of Co, Al, or both in the second composition relative to the first composition.

A cathode electrochemically active material optionally includes a non-uniform distribution of Co within the secondary particle wherein the non-uniform distribution is in the form of a gradient of Co within a crystallite, within the total secondary particle, or combinations thereof. Optionally, the crystallites include a gradient of Co concentration where the amount of Co at or near the outer periphery of a crystallite is greater than the concentration of Co at or near a center of the crystallite. Illustrative examples of such materials can be found in Lim, et al., Adv. Funct. Mater. 2015; 25:4673-4680 or in Lee et al., Journal of Power Sources, 2015; 273:663-669.

In some aspects, a non-uniform distribution of Co is achieved by coating a core with Co such as described in U.S. Pat. No. 7,381,496, U.S. Patent Application Publication No: 2016/0181611, or Zuo, et al., Journal of Alloys and Compounds, 2017; 706:24-40.

The positive electrode may be provided by combining the lithium nickel oxide, a conductive agent, and a binder, and providing a coating comprising the lithium nickel oxide, the conductive agent, and the binder on the current collector. The conductive agent may be any conductive agent that provides suitable properties and may be amorphous, crystalline, or a combination thereof. The conductive agent may include a carbon black, such as acetylene black or lamp black, a mesocarbon, graphite, carbon fiber, carbon nanotubes such as single wall carbon nanotubes or multi-wall carbon nanotubes, or a combination thereof.

A binder as used in either an anode or a cathode may be any binder that provides suitable properties and may include but not be limited to polyvinylidene fluoride, a copolymer of polyvinylidene fluoride, polyvinylidene difluoride (PVDF), hexafluoropropylene, poly(vinyl acetate), poly(vinyl butyral-co-vinyl alcohol-co vinyl acetate), poly(methylmethacrylate-co-ethyl acrylate), polyacrylonitrile, polyvinyl chloride-co-vinyl acetate, polyvinyl alcohol, poly(l-vinylpyrrolidone-co-vinyl acetate), cellulose acetate, polyvinylpyrrolidone, polyacrylate, polymethacrylate, polyolefin, polyurethane, polyvinyl ether, acrylonitrile-butadiene rubber, styrene-butadiene rubber, acrylonitrile-butadiene-styrene, tri-block polymer of sulfonated styrene/ethylene-butylene/styrene, polyethylene oxide, or a combination thereof.

The positive electrode may be manufactured by combining the lithium metal oxide, the conductive agent, and the binder in a suitable ratio, e.g., 80 to 99 weight percent of the lithium metal oxide, 0.5 to 20 weight percent of the conductive agent, and 0.5 to 10 weight percent of the binder, based on a total weight of the lithium metal oxide, the conductive agent, and the binder. The lithium metal oxide, the conductive agent, and the binder may be suspended in a suitable solvent, such as N-methylpyrrolidinone or other suitable solvent, and disposed on a suitable substrate, such as aluminum foil, and dried in air to provide the positive electrode.

An electrochemical cell as provided herein further includes a negative electrode. The negative electrode optionally includes a negative electrochemically active material defined by a redox potential of 400 mV or greater vs Li/Li⁺. Optionally the redox potential of the negative electrochemically active material vs Li/Li⁺ is 400 mV or greater, optionally 500 mV or greater, optionally 600 mV or greater, optionally 700 mV or greater, optionally 800 mV or greater, optionally 900 mV or greater, optionally 1 V or greater, optionally 1.1 V or greater, optionally 1.2 V or greater, optionally 1.3 V or greater, optionally 1.4 V or greater, optionally 1.5 V or greater, optionally 1.55 V or greater, optionally 1.6 V or greater.

Illustrative examples of a negative electrochemically active materials include but are not limited to oxides of Nb, Sn, Sb, Ti, Si, and combinations thereof, among others, optionally as long as the material is defined by a redox potential of 400 mV or greater vs Li/Li⁺. Specific illustrative examples may be found in Han and Goodenough, Chemistry of Materials, 23, no. 15 (2011): 3404-3407.

In some aspects, a negative electrochemically active material includes an oxide of Nb. Illustrative examples include, but are not limited to Nb₁₆W₅O₅₅, Nb₁₈W₁₆O₉₃, TiNb₂O₇, Ti₂Nb₂O₉, LiTiNbO₅, KNb₅O₁₃, and K₆Nb_{10.8}O₃₀. Such materials are optionally those as described by Griffith, et al., Nature, 559, no. 7715 (2018): 556-563.

Other examples of oxides that may be used as a negative electrochemically active material include SnO₂, Sb₂O₃, SiO, SiO₂ and conversion anodes, with the proviso that the negative electrochemically active material is characterize by a redox potential of 400 mV vs Li/Li⁺.

In some aspects, a negative electrochemically active material includes an oxide of Ti. An oxide of Ti may be in any form, optionally including a nanowire such as TiO₂—B nanowires as described by Armstrong, et al., Journal of Power Sources, 146, no. 1-2 (2005): 501-506.

One illustrative example is an oxide of titanium is a lithium titanium oxide (LTO), optionally having an electrochemical redox potential of greater than 1 V vs Li/Li⁺, optionally about 1.5 V vs Li/Li⁺. The lithium titanium oxide may have a spinel type structure. An anode may include an anode electrochemically active material optionally of the formula Li₄₊ₐTi₅O_{12+b} (2) wherein −0.3≤a≤3.3, −0.3≤b≤0.3. In some aspects the lithium titanium oxide may be of the formula 3

Li_{4+y}Ti₅O₁₂, (3)

wherein, 0≤y≤3, 0.1≤y≤2.8, or 0≤y≤2.6.

Alternatively, the lithium titanium oxide may be of Formula 4.

Li_{3+z}Ti_{6-z}O₁₂, (4)

where in formula 4, 0≤z≤1. Optionally 0≤z≤1, 0.1≤z≤0.8, or 0≤z≤0.5. A combination of anode electrochemically active materials including at least one of the foregoing lithium titanium oxides may be used. In some aspects an anode electrochemically active material includes or is Li₄Ti₅O₁₂ having an electrochemical redox potential of about 1.55 V vs Li/Li⁺.

The anode electrochemically active material may have any suitable particle size, such as a particle size of 0.1 μm to 100 μm, or 1 μm to 10 μm.

The anode electrochemically active material may have high specific surface area (SSA), such as 4 m²/g to 20 m²/g, or 7 m²/g to 13 m²/g.

The negative electrode includes a current collector. As is further discussed above, and while not wanting to be bound by theory, it is understood that because the electrochemical potential of the anode electrochemically active material is equal to or above 400 mV vs Li/Li⁺, the negative electrode current collector may include a metal other than copper because other metals, such as aluminum and titanium provide suitable stability at the potentials present when an anode electrochemically active material having an electrochemical redox potential of equal to or above 400 mV vs Li/Li⁺ is used. While not wanting to be bound by theory, it is understood that metals such as aluminum are electrochemically reactive with lithium at a potential of 0.1 volt to 0.5 volt versus lithium, whereas copper is not, which is why copper is used as a current collector material when graphite is used as an anode material. Thus a current collector comprising a metal which is electrochemically reactive with lithium at a potential of 0.1V to 0.5V, 0.15V to 0.45V, or 0.2V to 0.4V vs Li/Li⁺ may not be used for a graphite anode material, but may be used for an anode material as provided herein.

The current collector of the anode, cathode, or both may include aluminum, with aluminum or aluminum alloy being mentioned. Representative aluminum alloys include aluminum alloys 1050, 1100, 1145, 1235, 1350, 3003, 3105, 5052, and 6061.

The negative electrode may be formed by combining the anode electrochemically active material, an optional conductive agent, and a binder, and providing a coating comprising the anode electrochemically active material, the conductive agent, and the binder on the current collector selected for the negative electrode. The conductive agent may be any conductive agent that provides suitable properties and may be amorphous, crystalline, or a combination thereof. The conductive agent may be a carbon black, such as acetylene black or lamp black, a mesocarbon, graphite, carbon fiber, carbon nanotubes such as single wall carbon nanotubes or multi-wall carbon nanotubes, or a combination thereof. The binder may be any binder that provides suitable properties and may comprise polyvinylidene fluoride, PVDF, a copolymer of polyvinylidene fluoride and hexafluoropropylene, poly(vinyl acetate), poly(vinyl butyral-co-vinyl alcohol-co vinyl acetate), poly(methylmethacrylate-co-ethyl acrylate), polyacrylonitrile, polyvinyl chloride-co-vinyl acetate, polyvinyl alcohol, poly(l-vinylpyrrolidone-co-vinyl acetate), cellulose acetate, polyvinylpyrrolidone, polyacrylate, polymethacrylate, polyolefin, polyurethane, polyvinyl ether, acrylonitrile-butadiene rubber, styrene-butadiene rubber, acrylonitrile-butadiene-styrene, tri-block polymer of sulfonated styrene/ethylene-butylene/styrene, polyethylene oxide, or a combination thereof, for example.

The negative electrode may be manufactured by combining the anode electrochemically active material, the conductive agent, and the binder in a suitable ratio, e.g., 80 to 98 weight percent of the anode electrochemically active material, 2 to 20 weight percent of the conductive agent, and 2 to 10 weight percent of the binder, based on a total weight of the anode electrochemically active material, the conductive agent, and the binder. The anode electrochemically active material, the conductive agent, and the binder may be suspended in a suitable solvent, such as N-methylpyrrolidinone, and disposed on a suitable current collector, such as aluminum, titanium, or stainless steel, and dried in air to provide the negative electrode.

The positive and negative electrodes may be prepared at loadings (masses of coated material per unit area of current collector) that are tailored to the required rate capabilities and the voltage ranges of specific applications. Higher power (high rate) applications require lower loading electrodes so as to maximize electrode interfacial surface area and minimize current density, while applications needing higher energy density require higher loading electrodes so as to minimize the cell's content of inactive materials such as current collectors and separators.

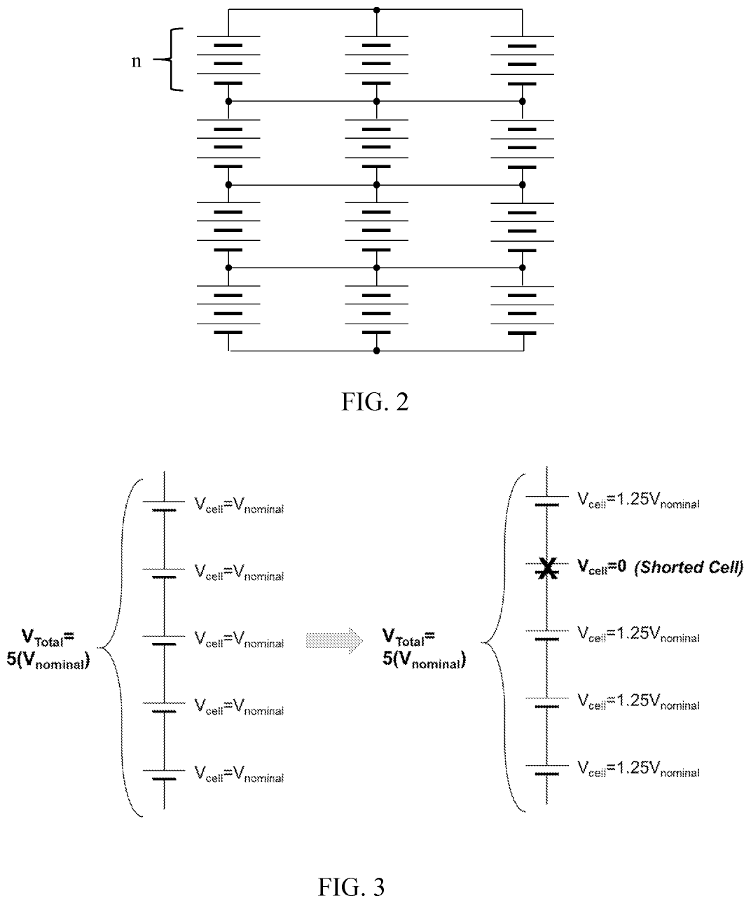

Batteries as provided herein may be provided in an array of cell units each with n cells. FIG. 2 depicts an illustrative aspect of the battery cell assembly described herein. Referring to FIG. 2, cell units of three cells (n=3) in series are connected to one another in a matrix. If the cells of FIG. 2 have a voltage range tolerance of at least 50% greater than the nominal operational voltage range, two cells of a three cell unit can be expanded to wider operational voltage range if one cell shorts such that the voltage that is no longer dropped across the shorted cell can be redistributed to the other two cells. As such, the other two cells in the series unit effectively isolate the shorted cell while allowing continued operation of the battery at normal capacity.

The array of cell units represents a connected architecture of x number of cell units connected in parallel and y number of cell units connected in series. The overall architecture of the battery provides the capability to not only prevent loss of performance of the overall battery due to the presence of a short in one or more of the individual cells in the array, but also the presence of such a short will not lead to discharge of other cells within the array should a short conduction be realized.

The number of cell units connected in parallel (x) is not particularly limited. It is appreciated that x may be 2, 3, 4, 5, 6, 7, 8, 9, 10 or more.

The number of cell units connected in series (y) is not particularly limited. It is appreciated that y may be 2, 3, 4, 5, 6, 7, 8, 9, 10 or more.

Optionally, the number of cell units connected in parallel (x) may be equal to the number of cell units connected in series (y). Optionally, the number of cell units connected in parallel (x) may be greater than the number of cell units connected in series (y). Optionally, the number of cell units connected in parallel (x) may be less than the number of cell units connected in series (y).

FIG. 3 depicts a illustrative aspects of a cell unit described herein. The cells in the cell unit of FIG. 3 have a voltage range tolerance of 25% or greater than the nominal (normal) operational voltage range of the battery array. As described previously, the number of n cells may be selected so that n≥3 and z(n−1)≥100. Thus, n if the desired voltage range tolerance is 25 percent greater than the nominal operational voltage range, n should be greater than or equal to 5. The cell unit depicted in FIG. 3 includes 5 cells in series as an example of such an arrangement.

Depicted in FIG. 3 is a normal state with all cells operating to nominal voltage range (i.e., the nominal voltage range associated with full charge-discharge cycling of the cell) and the voltage redistribution in full charge-discharge cycling following the formation of a short-circuit fault in one cell. If one cell shorts and, in the worst case, has zero voltage drop across the shorted cell, the remaining operational cells must compensate the voltage. Five or more cells in the basic unit of series-connected cells are required to accomplish this because with five cells, if one cell shorts and the voltage that would have been present at that shorted cell must be compensated by the other cells, a minimum of four cells is needed with each operating at the maximum expanded voltage range of 25% to total 100% of the voltage no longer present at the shorted cell. Because the shorted cell is within a series-connected cell unit, the shorted cell will not discharge any other cells elsewhere in the battery. Values of n greater than five when each cell has a voltage range tolerance of 25% greater than the nominal (normal) operational voltage range result in utilization of a fraction of the full 25% expansion of operational voltage range in the event of a shorted cell. The illustrative cell unit depicted in FIG. 3 exemplifies how, in the event of a short-circuit in one cell, expansion of operational voltage range of the other cells compensates for the loss of the shorted cell.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

The forgoing description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the systems or methods are described as an order of individual steps or using specific materials, it is appreciated that steps or materials may be interchangeable such that the description of the invention may include multiple systems or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects, but is not meant to be a limitation upon the practice thereof

We claim:

1. A battery cell assembly comprising:
a plurality of cell units;
wherein each of the cell units is connected in parallel with another cell unit; and
each of the cell units is connected in series with another cell unit;
wherein each of the cell units comprises n cells connected in series, the n cells having a voltage range tolerance of z % greater than a nominal operational voltage range;
wherein the n cells comprise a first end cell, a second end cell, and n−2 middle cells interposed between the first end cell and the second end cell; and
wherein n≥2 and z(n−1)≥100.

2. The assembly of claim 1, wherein n is 2, 3, 4, 5, 6, 7 or more.

3. The assembly of claim 1, wherein n is 3 or more.

4. The assembly of claim 1, wherein the number of cell units connected in parallel (x) is 2 or greater.

5. The assembly of claim 1, wherein the number of cell units connected in series (y) is 2 or greater.

6. The assembly of claim 1, wherein the anode, the cathode, or both comprise a current collector substrate comprising aluminium.

7. The assembly of claim 1, wherein the anode and cathode are in a pouch cell.

8. The assembly of claim 1, wherein a cell within said cell unit comprises a cathode, the cathode comprising a polycrystalline cathode electrochemically active material comprising the formula Li₁₊ₓMO_{2+y}, wherein −0.9≤x≤0.3, −0.3≤y≤0.3, and wherein M comprises Ni at 80 atomic percent or higher relative to total M, the cathode electrochemically active material comprising a non-uniform distribution of Co; and
an anode comprising an electrochemically active material with an electrochemical redox potential of at least 400 mV versus Li/Li+; and wherein the cell is optionally anode limited in capacity, area or both.

9. The assembly of claim 8, wherein the anode electrochemically active material comprises an oxide of Nb, Sn, Sb, Ti, Si, or combinations thereof.

10. The assembly of claim 8, wherein the anode electrochemically active material comprises an oxide of Nb.

11. The assembly of claim 8, wherein the anode electrochemically active material comprises an oxide of Ti.

12. The assembly of claim 8, wherein the oxide of Ti has the formula Li₄₊ₐTi₅O_{12+b} wherein −0.3≤a≤3.3, −0.3≤b≤0.3.

13. The assembly of claim 8, wherein the anode electrochemically active material has an electrochemical redox potential versus lithium metal of 1 Volt or greater.

14. The assembly of claim 8, wherein the cathode electrochemically active material includes a plurality of crystallites and a grain boundary between the plurality of crystallites, wherein a concentration of cobalt, aluminum, or both is higher in the grain boundary than in a center of the adjacent crystallites.

15. The assembly of claim 8, M in the formula Li₁₊ₓMO_{2+y} comprises Ni and one or more metals selected from the group consisting of Mg, Sr, Co, Al, Ca, Cu, Zn, Mn, V, Ba, Zr, Ti, Cr, Fe, Mo, B, and any combination thereof.

16. The assembly of claim 8, wherein the cathode electrochemically active material comprises Ni and one or more of Mg, Co, or Al.

17. The assembly of claim 1, wherein the middle cells are absent a parallel connection.

18. A method of compensating for a voltage loss from a shorted cell, the method comprising:
expanding an operational voltage range of n−1 operational cells of a cell unit by z % over a nominal operational voltage range such that z(n−1)≥100;
wherein the cell unit comprises n cells connected in series, the n cells comprising a first end cell, a second end cell, and n−2 middle cells interposed between the first end cell and the second end cell; and
the n cells comprise the shorted cell and the operational cells;
wherein n≥3.

19. The method of claim 18, wherein n is 2, 3, 4, 5, 6, 7 or more.

20. The method of claim 18, wherein n is 3 or more.

21.-34. (canceled)
